(19) United States
(12) Patent Application Publication
(10) Pub. No.: US 2026/0300642 A1
(43) Pub. Date: Oct. 1, 2026

(54) GENERATION AND VALIDATION OF MULTIPLE CHOICE QUESTIONS (MCQS) ALIGNED WITH EDUCATIONAL STANDARDS USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Sean Carlson, Savage, MN (US); Simon Said, Malta (MT); Pranav Kalyan, Auroura Hills, CA (US); Nima Shirazian, Palo Verdes Peninsula, CA (US); Wesley Stander, Porto (PT); Minas Magdi, Alexandria (EG)

(73) Assignee: 2hr Learning, Inc., Austin, TX (US)

(21) Appl. No.: 19/368,822

(22) Filed: Oct. 24, 2025

Related U.S. Application Data
(60) Provisional application No. 63/711,683, filed on Oct. 24, 2024.

(51) Int. Cl. G06F 40/40; G06F 11/3604; G06F 40/30; G06T 11/00; G09B 7/06

(52) U.S. Cl. CPC G06F 40/40; G06F 11/3608; G06F 40/30; G06T 11/00; G09B 7/06

(57) ABSTRACT

A multiple-choice question (MCQ) generation and validation system and method aligned with educational standards using a multiagent artificial intelligence (AI) engine 110. The MCQ generation and validation system and method comprises a data model 106, a content generation system 104, and the multiagent AI engine 110. The multiagent AI engine 110 includes a generator agent for creating initial MCQ drafts and a validation process to ensure correctness, completeness, and alignment with standards. The MCQ generation and validation system and method employ multiple validation cycles and pre-processing steps to refine the questions generated. With the questions failing, these checks are being discarded. The MCQ generation and validation system and method streamline the creation of high-quality, standards-aligned MCQs for educational purposes.

### CROSS-REFERENCE TO RELATED APPLICATION(S)

This application claims the benefit under 35 U.S.C. § 119(e) and 37 C.F.R. § 1.78 of U.S. Provisional Application No. 63/711,683, which is incorporated by reference in its entirety.

### FIELD OF THE INVENTION

The present invention relates in general to the field of electronics, and more specifically to a system and method for generation and validation of MCQs aligned with educational standards.

### BACKGROUND

Different educational systems employ various systems and methods for generating and validating MCQs, such as question banks, manual MCQ generation, online MCQ generators, and single-stage validation. These systems and methods have limitations that prevent users from accessing better opportunities.

Question banks offer different sets of questions for users. The users are given questions and allowed to choose the answer for practice. But the question banks were not able to produce specific questions related to a particular topic if a user required them. This restricts users' interest in studying the specific topics.

Manual MCQ generation proceeds slowly and is prone to human error and bias. This method limits question availability to users and makes expansion difficult due to its human-centric nature. If the manual MCQ generation is good, there will be a limitation for the admission, which restricts the opportunity of other users. In the manual MCQ generation, users cannot choose personalized MCQ questions and must follow the set of questions created by the person whom so ever creating.

Online MCQ generators create mathematics MCQs with advantages in scalability and question personalization to some extent. However, the online MCQ generator often makes mistakes while producing mathematical questions. Moreover, the online MCQ generator may generate inaccurate information making them non-reliable source for question generation.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary MCQ generation and validation system.

FIG. 2 depicts an exemplary MCQ generation and validation method, utilized by the MCQ generation and validation system.

FIG. 3 depicts a functional block diagram for the MCQ generation and validation method, which is an embodiment of the MCQ generation and validation method of FIG. 2.

FIG. 4 depicts a data structure for the MCQ generation and validation method.

FIG. 5 depicts an exemplary network environment in which the system of FIG. 1 and the process of FIG. 2 may be practiced.

FIG. 6 depicts an exemplary computer system.

FIGS. 7 and 8 depict examples for a final output given to a user interface.

### DETAILED DESCRIPTION

A multiple choice question (MCQ) generation and validation system 100 and method for generating and validating MCQs receive data from a data model 106 and use a content generation system 104 to generate MCQs. The content generation system 104 receives user input via a user interface 102 and data from the data model 106 to generate one or more MCQs. The content generation system 104 includes a prompt generator 108 configured to generate a prompt 109 based on the received input and data. The content generation system 104 then shares the prompt with a multiagent AI engine 110. The multiagent AI engine 110 include multiple assistants and additional validation checks 118 to process the prompt and generate output that is one or more validated MCQs, which are then transferred to the user via the user interface 102.

The MCQ generation and validation system 100 specifically generates and validates mathematics MCQ questions. The MCQ generation and validation system 100 passes each question through multiple validation stages before generating the final output (i.e. validated MCQs). If an MCQ question fails at any validation stage, the MCQ question is discarded, ensuring only high-quality multiple choice questions are generated and shared with the user. This helps prevent misinformation, allowing users to learn confidently, knowing that the output is reliable.

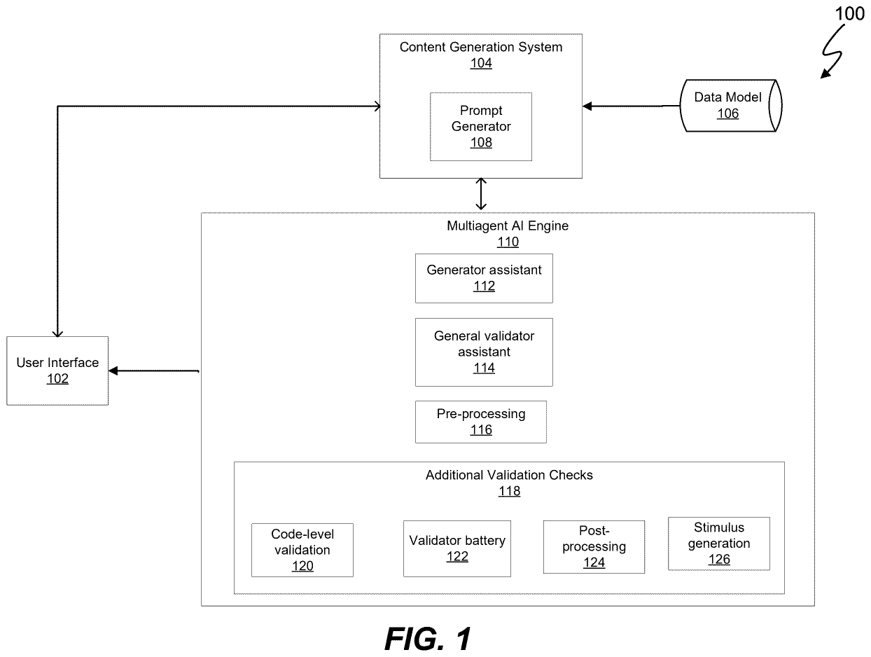

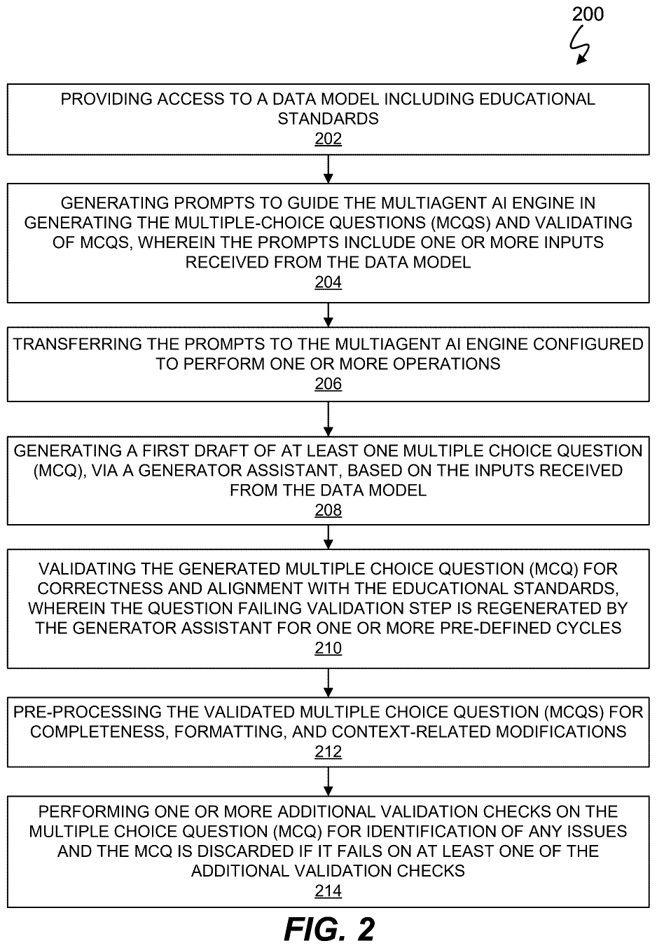

FIG. 1 depicts an exemplary MCQ generation and validation system, and FIG. 2 depicts an exemplary MCQ generation and validation method, utilized by the MCQ generation and validation system of FIG. 1.

Referring to FIGS. 1 and 2, in operation 202, the data model 106 provides access to data for the content generation system 104. The data model 106 includes educational standards, sub-standards, and granular details related to the standards for generating multiple-choice questions (MCQs). The data model 106 includes data used for generation of MCQs in data structures and configuration settings.

The educational standards, set clear expectations for student learning, guide curriculum development, ensure consistent evaluation, and promote accountability in the education system. The educational standard, for example, CCSS.MATH.CONTENT.8.EE.A.4 is an eighth-grade math standard that focuses on operations with numbers expressed in scientific notation. The CCSS.MATH.CONTENT.8.EE.A.4 standard requires students to perform calculations using numbers in scientific notation, including problems where both decimal and scientific notation are used. Students should be able to convert between these formats as needed for problem-solving. The CCSS.MATH.CONTENT.8.EE.A.4 standard emphasizes the practical application of scientific notation in real-world contexts. The students learn to use scientific notation to represent very large or very small quantities effectively. Additionally, the CCSS.MATH.CONTENT.8.EE.A.4 standard addresses technology integration. The students should be able to interpret scientific notation generated by calculators or other technological tools. A CCSS.MATH.CONTENT.8.EE.A.4+2 is an extension of the main standard, focusing specifically on the use of scientific notation for measurements. The CCSS.MATH.CONTENT.8.EE.A.4+2 requires students to not only express numbers in scientific notation but also to choose appropriate units for very large or very small quantities.

Another example is a CCSS.MATH.CONTENT.1.OA.A.1+1 is a first-grade math standard that focuses on addition within 20 to solve word problems. The CCSS.MATH.CONTENT.1.OA.A.1+1 standard requires students to use addition in various situations, including adding to an existing amount, combining separate quantities, and comparing quantities. The students must solve these problems with unknowns in all positions, using objects or drawings to represent the problem. The learning objectives for the CCSS.MATH.CONTENT.1.OA.A.1+1 standard are comprehensive. The students should solve addition word problems involving adding a quantity to an existing amount, with the total sum not exceeding 20. The student needs to also solve problems that involve combining two separate quantities to find a total sum within 20. Additionally, students should compare two quantities to determine their total sum, again within 20.

The data used by a generator assistant 112 includes assistant ID, tool choice, and input message structure. Where the assistant ID uniquely identifies each of the generator assistant 112 responsible for creating questions based on specific educational standards. assistant ID actively maps the generator assistant 112 to the relevant standard in the data model 106. The tool choice specifies which tool the generator assistant 112 will use to create the questions. The tool choice determines the method or technology applied, such as a code interpreter or a natural language processing model to generate appropriate content. The input message structure organizes the core information needed for question generation. Input message structure formats and delivers inputs such as grade level, educational standard, example questions, and stimulus specifications, which include stimulus type specifications and example stimulus descriptions, to guide the generator assistant 112 in producing accurate MCQs. The stimulus can be defined as a visual representation of an image that helps in solving the mathematical problems. Examples of stimulus include bar graphs, mathematical shapes, and line graphs.

The configuration settings for the generator assistant 112 include instructions, models, functions, and temperature. Where the instructions are the prompt given to the multiagent AI engine 110 for generating MCQs, the model refers to the underlying multi-agent AI engine 110 that generates the MCQs based on provided inputs. The function takes input parameters, processes them according to predefined instructions, and returns an output. The temperature in the multiagent AI engine 110 controls the randomness of the output. A lower temperature results in more deterministic and focused responses, while a higher temperature introduces more creativity and variability in the generated content.

The data provided to a general validator assistant 114 includes assistant ID, tool choice, and input message structure. Where the assistant ID uniquely identifies each of the general validator assistant 114 responsible for the correctness of questions from the generator assistant 114. The assistant ID actively maps the general validator assistant 114 to the relevant standard in the data model 106. The tool choice specifies which tool the general validator assistant 114 will use to correct the questions. The tool choice determines the method or technology applied, such as a code interpreter or a natural language processing model, to generate appropriate content. The input message structure organizes the core information needed for correcting questions generated. Input message structure formats and delivers inputs such as MCQ from the generator assistant 112 and stimulus specifications, which include stimulus description (if stimulus-based) and stimulus type specifications (if stimulus-based).

The configuration settings for the general validator assistant 114 include instructions, models, functions, and temperature. Where the instructions are the prompt given to the multiagent AI engine 110 for correction of MCQs. The model refers to the underlying multi-agent AI engine 110 that generates the MCQs based on provided inputs. The function takes input parameters, processes them according to predefined instructions, and returns an output. The temperature in the multi-agent AI engine 110 controls the randomness of the output. A lower temperature results in more deterministic and focused responses, while a higher temperature introduces more creativity and variability in the generated content.

The data used for preprocessing 116 includes a preprocessing function name(s) and an input, where the input is MCQ in concatenated question format. The configuration settings for processor used for preprocessing 116 include instructions, model, tool, functions, and temperature. Where the instructions are the prompt given to the multi-agent AI engine 110 for LaTex formatting. The model refers to the underlying multi-agent AI engine 110 that converts the JSON into LaTex format. The tool choice determines the method or technology applied, such as a code interpreter or a natural language processing model, to generate appropriate content. The function takes input parameters, processes them according to predefined instructions, and returns an output. The temperature in the multi-agent AI engine 110 controls the randomness of the output. A lower temperature results in more deterministic and focused responses, while a higher temperature introduces more creativity and variability in the generated content.

The configuration settings for a code-level validation 120 include code-level validation functions that programmatically validate each MCQ based on its stimulus type or educational standard. The code-level validation functions assess the generated question against specific criteria and determine whether it passes or fails. If the MCQ passes all relevant checks, the MCQ proceeds to the next step; if the MCQ fails any check, it is discarded, and the process restarts from the generator assistant 112.

In at least one embodiment, the code-level validation functions used are as below:

```
  def assert_all_answers_contain (self, substr: str):
    ″″″
    Assert that all answer texts contain the given substring.
    :param substr: The substring that should be present in
all answer texts.
    ″″″
    for answer in self.answers:
      assert (
        substr in answer.text
      ), f″{self.substandard_id}: Answer ′{answer.text}′
does not contain ′{substr}′″
```

The assert_all_answers_contain function checks if every answer text includes a specified substring. The assert_all_answers_contain function iterates through all answers and asserts that the substring is present in each one. If an answer does not contain the substring, it raises an assertion error with a message indicating the issue.

The data provided to a validator battery 122 includes assistant ID, tool choice, and input message structure. Where the assistant ID uniquely identifies each of the generator assistant 112 responsible for creating questions based on specific educational standards. Assistant ID actively maps the validator battery 122 to the relevant standard in the data model 106. The tool choice specifies which tool the validator battery 122 will use to evaluate each MCQ. The tool choice determines the method or technology applied, such as a code interpreter or a natural language processing model, to evaluate each MCQ. The input message structure organizes the core information needed to evaluate each MCQ. Input message structure formats and delivers inputs such as MCQ, stimulus description (if stimulus-based), and stimulus type specifications (if stimulus-based) guiding the validator battery 122 to evaluate each MCQ.

The configuration settings for the validator battery 122 include instructions, model, functions, and temperature. Where the instructions are the prompt given to the multi-agent AI engine 110 to evaluate each MCQ, the model refers to the underlying the multi-agent AI engine 110 that evaluates each MCQ based on provided inputs. The function takes input parameters, processes them according to predefined instructions, and returns an output. The temperature in the multi-agent AI engine 110 controls the randomness of the output. A lower temperature results in more deterministic and focused responses, while a higher temperature introduces more creativity and variability in the generated content.

The data used for postprocessing 124 includes a postprocessing function stored as a list of function names mapped to each standard. The configuration settings for the postprocessing 124 include postprocessing functions that programmatically modify each MCQ based on its stimulus type or standard. The post-processing 124 takes input as MCQ and curriculum data.

In at least one embodiment, the post-processing function is as given below:

```
  def pp_decimals_to_latex_fractions (string):
    ″″″
    Converts decimal numbers in the given string to LaTeX
fractions.
    Args:
      string (str): The input string containing decimal
numbers.
    Returns:
      str: The string with decimal numbers converted to LaTeX
fractions.
    ″″″
    def decimal_replacer(match):
      decimal_number = match.group(0)
      fraction = Fraction(decimal_number).limit_denominator( )
      latex_fraction =
f″\\frac{{{fraction.numerator}}}{{{fraction.denominator}}}″
      if (
        match.start( ) > 0
        and string[match.start( ) − 1] == ″$″
        and match.end( ) < len(string)
        and string[match.end( )] == ″$″
      ):
        return latex_fraction
      return f″${latex_fraction}$″
    decimal_pattern = re.compile(r″\b\d+\.\d+\b″)
    return decimal_pattern.sub(decimal_replacer, string)
```

The pp_decimals_to_latex fractions function converts decimal numbers in a given string to LaTeX fractions. The pp_decimals_to_latex fractions function uses a regular expression to find decimal numbers and replace them with LaTeX formatted fractions. The function checks if the decimals are enclosed in dollar signs and formats them accordingly, ensuring correct LaTeX representation for each decimal number.

The configuration settings for a stimulus generation 126 include a stimulus generation function for each stimulus type that automatically generates images based on the stimulus description.

In at least one embodiment, the stimulus generation function is as given below:

```
  def plot_points(stimulus_description):
    fig, ax = plt.subplots( )
    x_title = stimulus_description[′x_title′]
    y_title = stimulus_description[′y_title′]
    points = stimulus_description[′points′]
    for point in points:
      label = point[′label′]
      x = point[′x′]
      y = point[′y′]
      ax.scatter (x, y, label=label)
      ax.text (x + 0.1, y + 0.1, label, fontsize=10) #
Small offset for the labels
    x_values = [point[′x′] for point in points]
    y_values = [point[′y′] for point in points]
    x_min = min(x_values) − 1
    x_max = max(x_values) + 1
    y_min = min(y_values) − 1
    y_max = max(y_values) + 1
    # Determine the smallest non-zero step size
    steps = [abs(point[′x′]) for point in points if point
[′x′] != 0] + [abs(point[′y′]) for point in points if point
[′y′] != 0]
    step = min (steps) if steps else 1
    step = min (step, 1) # Ensure the step is not greater
than 1 if step size is inconsistent
    ax.set_xticks(np.arange (x_min, x_max, step=step))
    ax.set_yticks(np.arange (y_min, y_max, step=step))
    ax.set_xlim(x_min, x_max)
    ax.set_ylim(y_min, y_max)
    ax.axhline (0, color=′black′, linewidth=0.5) # X-axis
    ax.axvline (0, color=′black′, linewidth=0.5) # Y-axis
    ax.grid(True, which=′both′, linestyle=′--′, linewidth=
    0.5)
    ax.set_xlabel (x_title if x_title else ′X-axis′)
    ax.set_ylabel (y_title if y_title else ′Y-axis′)
    plt.legend( )
    file_name = (
f″{IMAGE_DESTINATION_FOLDER}/graphing_
coordinate_planes_{int(time.time( ))}.png″
    )
    plt.savefig(file_name, transparent=True, bbox_
    inches=″tight″)
    plt.tight_layout ( )
    plt.close( )
    return file_name
```

The plot_points function creates and saves a scatter plot based on the provided stimulus_description. The plot_points function sets up a figure and axis, plots points with labels, adjusts axis limits and ticks based on the data, and adds gridlines and axis labels. The plot_points function then saves the plot as a PNG file with a timestamp in the filename and returns the file path.

In operation 204, a prompt generator 108 present inside the content generation system 104 generates prompts to guide the multiagent AI engine 110 in generating the multiple-choice questions (MCQs) and validating the MCQs, wherein the prompts include one or more inputs received from the data model 106. The basic structure of the prompt is created by the prompt engineer through the method of prompt engineering, and the modification to the prompt is made by the prompt generator 108.

For generating prompts for the generator assistant 112, the prompt generator 108 collects the data from the data model 106 for the generator assistant 112. The data used for the generator assistant 112 includes assistant ID, tool choice, and input message structure.

The input message structure includes grade level, standard description, example question, example stimulus description (if stimulus-based), stimulus type specifications (if stimulus-based). The grade level specifies the educational level targeted. Standard description defines the learning objective, aligning content with curriculum requirements and educational standards. Example question, Provides a sample query for what kind of question the user needs. Example Stimulus Description (if stimulus-based), Describes the material (text, image, etc.) that the user must analyze to answer the question. Stimulus type specifications (if stimulus-based) detail the required characteristics of the stimulus.

Example for the input from the user interface 102 and the data model 106 combined for the modification of input prompt created by prompt engineer.

| | |
|---|---|
| Grade Level | 6 |
| Standard | Find and position pairs of integers and other rational |
| Description | numbers on a coordinate plane. |
| Example | { |
| Question | ″question″: ″Which point is located at (−3.5, 2) on the |
| | coordinate plane?″, |
| | ″answer_options″: [ |
| | { |
| | ″id″: ″A″, |
| | ″answer″: ″Point A″, |
| | ″correct″: true, |
| | ″explanation″: ″Point A is located at (−3.5, 2), |
| | which matches the coordinates given.″ |
| | }, |
| | { |
| | ″id″: ″B″, |
| | ″answer″: ″Point B″, |
| | ″correct″: false, |
| | ″explanation″: ″Point B is located at (3, −2.5), |
| | which does not match the coordinates given.″ |
| | }, |
| | { |
| | ″id″: ″C″, |
| | ″answer″: ″Point C″, |
| | ″correct″: false, |
| | ″explanation″: ″Point C is located at (−2.5, 3), |
| | which does not match the coordinates given.″ |
| | }, |
| | { |
| | ″id″: ″D″, |
| | ″answer″: ″Point D″, |
| | ″correct″: false, |
| | ″explanation″: ″Point D is located at (2, −3.5), |
| | which does not match the coordinates given.″ |
| | } |
| | ] |
| | } |
| Example | { |
| Stimulus | ″x_title″: ″X″, |
| Description | ″y_title″: ″Y″, |
| | ″points″: [ |
| | { |
| | ″label″: ″A″, |
| | ″x″: −3.5, |
| | ″y″: 2 |
| | }, |
| | { |
| | ″label″: ″B″, |
| | ″x″: 3, |
| | ″y″: −2.5 |
| | }, |
| | { |
| | ″label″: ″C″, |
| | ″x″: −2.5, |
| | ″y″: 3 |
| | }, |
| | { |
| | ″label″: ″D″, |
| | ″x″: 2, |
| | ″y″: −3.5 |
| | } |
| | ] |
| | } |
| Stimulus | Summary: |
| Type | The Stimulus is a coordinate plane with an x-axis and y- |
| Specifi- | axis. Data points are plotted on the coordinate plane. |
| cations | The axes each have a label based on the content of the |
| | question. If there are no obvious axis titles based on the |
| | question, the x-axis should be titled ″X″ and the y-axis |
| | ″Y″. |
| | Specifications: |
| | - Data points are plotted based on their X and Y |
| | coordinates |
| | - Minimum of 4 data points and maximum of 6 data |
| | points |
| | - The maximum value of any coordinate is 12 |
| | - Coordinates must all be integers or simple decimals, |
| | like 6.5 or −4.25 |

In at least one embodiment, a function can serve as the prompt. The prompt generator 108 modifies the input message structure, including the assistant ID and tool choice, based on the data from the user interface 102 and the data model 106

In at least one embodiment, the input prompt created by the prompt engineer:

```
  {
  ″asst″: ″asst_7U2vR5SoZ6VPdouOTcc8Ki0h″,
  ″tool″: ″code_interpreter″,
  ″inputMsg″: [
    ″Core Inputs:″,
      ″--------″,
      ″Grade Level: {{ grade }}″,
      ″Educational Standard: {{ standardDescription }}″,
      ″Stimulus Type Specifications: {{ stimulusTypeSpecification
}}″,
      ″Example Question: {{ question }}″,
      ″Example Stimulus Description: {{ exampleStimulusDescription
}}″
    ]
  }
```

For generating prompts for general validator assistant 114, the prompt generator 108 collects data regarding assistant ID, tool choice, and input message structure. The input message structure includes MCQ from the generator assistant 112, stimulus description (if stimulus-based), and stimulus type specifications (if stimulus-based).

Example for the input from the generator assistant 112, the user interface 102, and the data model 106 combined for the modification of the input prompt created by the prompt engineer.

| | |
|---|---|
| MCQ | Question: Which point is at $(1, −2)$ on the coordinate |
| | plane?\ \ |
| | Option A:\ |
| | Answer: Point A\ |
| | Correct: False\ \ |
| | Option B:\ |
| | Answer: Point B\ |
| | Correct: False\ \ |
| | Option C:\ |
| | Answer: Point C\ |
| | Correct: True\ \ |
| | Option D:\ |
| | Answer: Point D\ |
| | Correct: False\ \ |
| | Explanation: Point C is located at $(1, −2)$, which |
| | matches the coordinates given. |
| Stimulus | { |
| | ″x_title″: ″X″, |
| | ″y_title″: ″Y″, |
| | ″points″: [ |
| | { ″label″: ″A″, ″x″: 8, ″y″: −1 }, |
| | { ″label″: ″B″, ″x″: −1, ″y″: 10 }, |
| | { ″label″: ″C″, ″x″: 1, ″y″: −2 }, |
| | { ″label″: ″D″, ″x″: 1, ″y″: 4 } |
| | ] |
| | } |
| Stimulus | Summary: |
| Type | The Stimulus is a coordinate plane with an x-axis and y- |
| Specifi- | axis. Data points are plotted on the coordinate plane. The |
| cations | axes each have a label based on the content of the question. |
| | If there are no obvious axis titles based on the question, |
| | the x-axis should be titled ″X″ and the y-axis ″Y″. |
| | Specifications: |
| | - Data points are plotted based on their X and Y coordinates |
| | - Minimum of 4 data points and maximum of 6 data points |
| | - The maximum value of any coordinate is 12 |
| | - Coordinates must all be integers or simple decimals, like |
| | 6.5 or −4.25 |

In at least one embodiment, a function can serve as the prompt. The prompt generator 108 modifies the input message structure, the assistant ID, and tool choice based on the data from the user interface 102, the data model 106, and the generator assistant 112.

In at least one embodiment, an exemplary input prompt template created by the prompt engineer is subsequently presented, and the prompt generator assistant 112 programatically populates the prompt with desired input constraint data, such as MCQ, Stimulus, and Stimulus Type, i.e. the respective information for generatedQuestion, generatedStimulus, and stimulusTypeSpecification. Exemplary respective information is set forth below in TABLE 1.

```
  {
    ″asst″: ″asst_909KqdHq0j606i3fAxUWHkGQ″,
    ″tool″: ″code_interpreter″,
    ″inputMsg″: [
      ″Core Inputs:″,
      ″--------″,
      ″MCQ: {{ generatedQuestion }}″,
      ″Stimulus: {{ generatedStimulus }}″,
      ″Stimulus Type Specifications: {{ stimulusTypeSpecification
}}″
    ]
  }
```

For generating prompts for the validator battery 122, prompt generator 108 collects data regarding assistant ID, tool choice, and input message structure. The input message structure includes MCQ, stimulus description (if stimulus-based), stimulus type specifications (if stimulus-based), and the MCQ question created by the generator assistant 112.

Example for the input from the generator assistant 112, the user interface 102, and the data model 106 combined for the modification of the input prompt template to generate a prompt to guide and constrain the AI engine 110.

TABLE 1

| | |
|---|---|
| MCQ | Question: Which point is at $(1, −2)$ on the coordinate |
| | plane?\ \ |
| | Option A:\ |
| | Answer: Point A\ |
| | Correct: False\ \ |
| | Option B:\ |
| | Answer: Point B\ |
| | Correct: False\ \ |
| | Option C:\ |
| | Answer: Point C\ |
| | Correct: True\ \ |
| | Option D:\ |
| | Answer: Point D\ |
| | Correct: False\ \ |
| | Explanation: Point C is located at $(1, −2)$, which |
| | matches the coordinates given. |
| Stimulus | { |
| | ″x_title″: ″X″, |
| | ″y_title″: ″Y″, |
| | ″points″: [ |
| | { ″label″: ″A″, ″x″: 8, ″y″: −1 }, |
| | { ″label″: ″B″, ″x″: −1, ″y″: 10 }, |
| | { ″label″: ″C″, ″x″: 1, ″y″: −2 }, |
| | { ″label″: ″D″, ″x″: 1, ″y″: 4 } |
| | ] |
| | } |
| Stimulus | Summary: |
| Type | The Stimulus is a coordinate plane with an x-axis and y- |
| Specifi- | axis. Data points are plotted on the coordinate plane. The |
| cations | axes each have a label based on the content of the question. |
| | If there are no obvious axis titles based on the question, |
| | the x-axis should be titled ″X″ and the y-axis ″Y″. |
| | Specifications: |
| | - Data points are plotted based on their X and Y coordinates |
| | - Minimum of 4 data points and maximum of 6 data points |
| | - The maximum value of any coordinate is 12 |
| | - Coordinates must all be integers or simple decimals, like |
| | 6.5 or −4.25 |

In at least one embodiment, a function can serve as the prompt. The prompt generator 108 modifies the input message structure, the assistant ID, and tool choice based on the data from the user interface 102, the data model 106, and the generator assistant 112.

In at least one embodiment, an exemplary input prompt template created by the prompt engineer is subsequently presented, and the prompt generator assistant 112 programatically populates the prompt with desired input constraint data, such as MCQ, Stimulus, and Stimulus Type, i.e. the respective information for generatedQuestion, generatedStimulus, and stimulusTypeSpecification. Exemplary respective information is set forth below in TABLE 1.

```
  {
    ″asst″: ″asst_m5jNbNrBVZA36fiKD1BuObeU″,
    ″tool″: ″code_interpreter″,
    ″inputMsg″: [
      ″Core Inputs:″,
      ″--------″,
      ″MCQ: {{ generatedQuestion }}″,
      ″Stimulus: {{ generatedStimulus }}″,
      ″Stimulus Type Specifications: {{ stimulusTypeSpecification
}}″
    ]
  }
```

In operation 206, the prompts to the multi-agent AI engine 110 are configured to perform one or more operations, where the prompt modified by the prompt generator 108 is transferred along with the prompt created by the prompt engineer to do specific tasks (instructions), models, functions, and temperatures.

An exemplary prompt created by the generator assistant 112 to specially guide and constrain the AI engine 110 is:

Context
You are a Mathematics Multiple-Choice Question (MCQ) generator.
Your job is to create a challenging but fair MCQ for a mathematics exam
of the given Grade Level.
Task
1. Use the Educational Standard to generate an MCQ question along
with a Stimulus Description. Mimic the style and structure of the
Example Question and Example Stimulus while ignoring their content.
2. Generate four answer choices for the MCQ. Exactly one of the
answer choices must be correct.
3. Each answer must be accompanied by an explanation as to why
this answer is correct or incorrect.
4. Output the generated multiple-choice question (MCQ) using the
functions.generateMCQ4Choice tool.
Rules
Formatting:
* Do NOT include large, complicated fractions such as 17/190 in
any outputs. Fractions, if included, should be simple, such as ⅞ or
⅗.
* For all outputs: write out “pi,” “e,” or the mathematical
representations of them. Do not write out “3.14159265 . . . ” or
“2.718 . . . ”.
* If any decimal places are truncated in the answer choices,
ensure the question wording matches the truncation/rounding (e.g.
“Round to the nearest integer”).
Stimulus Description:
* Use the Summary given in the Stimulus Type Specifications to
understand the type of stimulus which can be created.
* Follow the Specifications given in Stimulus Type
Specifications.
* Create a Stimulus Description using a similar structure to the
Example Stimulus Description while ignoring its content.
* Integrate the MCQ with the visuals that the Stimulus
Description describes
* Generate the minimum number of visual Stimuli necessary to
create a solvable MCQ. Do not generate any Stimuli that will not be
referenced by either the Answer Choices or Question.
Question:
* Assume a visual stimulus following the generated Stimulus
Description is given. Create an MCQ to accompany this stimulus.
* Do not explicitly state the Stimulus Description.
* The generated MCQ MUST conform to a multiple-choice format
* The question should not ask for anything except one correct
answer.
Answer Choices:
* There must only be 1 correct answer. There should be no
ambiguity between the correct and incorrect answers for a student of
the Grade Level besides knowledge of the Educational Standard
* Ensure that answer choices cannot be immediately discounted due
to question formatting, such as formatting differences between the
correct answer choice and the incorrect answer choice.
Answer Explanations:
* The correct answer choice explanation should give a clear,
coherent, step-by-step explanation for the correct answer
* Ignore the tone of the answer explanations from the Example
Question. Use a neutral tone that is not targeted at any demographic.
* Incorporate the stimulus described by the Stimulus Description
into the explanation if relevant.
* Do not explicitly state the Stimulus Description.
Output Template
Question: The text-based component of the MCQ
Stimulus Description: An array, detailing the stimulus to be
generated. The format should be aligned with the Example Question.
A Explanation: The explanation for the correctness of answer
choice A
A Correct: The correctness of answer choice A
B Text: The text for answer choice B
B Explanation: The explanation for the correctness of answer
choice B
B Correct: The correctness of answer choice B
C Text: The text for answer choice C
C Explanation: The explanation for the correctness of answer
choice C
C Correct: The correctness of answer choice C
D Text: The text for answer choice D
D Explanation: The explanation for the correctness of answer
choice D
D Correct: The correctness of answer choice D

The prompt asks the multiagent AI engine 110 generate a challenging but fair mathematics MCQ for a specified grade level. The multiagent AI engine 110 task is to use an educational standard to create the MCQ, following a specific format and structure. The MCQ is accompanied by a visual stimulus, which the multiagent AI engine 110 will describe in detail, mimicking the style of a provided example without copying its content.

The multiagent AI engine 110 must generate four answer choices for the MCQ, ensuring that exactly one of them is correct. For each answer choice, the multiagent AI engine 110 writes an explanation, clarifying why the answer is correct or incorrect. The multiagent AI engine 110 needs to format the questions and answers according to strict rules: avoid complicated fractions, use simple mathematical symbols like “pi” or “e,” and ensure the wording matches any rounding or truncation in the answers.

The stimulus the multiagent AI engine 110 describes should be minimal yet sufficient to solve the MCQ. The multiagent AI engine 110 should seamlessly integrate the visual stimulus into the question and answers, ensuring they reference the stimulus where relevant. The final output should follow a specific template, providing a clear, step-by-step explanation for the correct answer, using a neutral tone, and avoiding demographic targeting.

### Function:

```
  {
    ″name″: ″generateMCQ4Choice″,
    ″description″: ″Generate a Multiple-Choice Question (MCQ) for
math students based on the Grade Level, Educational Standard, and
Example Question, including a possible visual stimulus.″,
    ″parameters″: {
      ″type″: ″object″,
      ″properties″: {
        ″question_text_with_inline_latex″: {
            ″type″: ″string″,
          ″description″: ″The multiple-choice question written in
text with inline LaTeX.″
        },
        ″stimulus_description″: {
          ″type″: ″object″,
          ″properties″: {
            ″x_title″: {
              ″type″: ″string″
            },
            ″y_title″: {
              ″type″: ″string″
            },
            ″points″: {
              ″type″: ″array″,
              ″items″: {
                ″type″: ″object″,
                ″properties″: {
                  ″label″: {
                    ″type″: ″string″
                  },
                  ″x″: {
                    ″type″: ″integer″
                  },
                  ″y″: {
                    ″type″: ″integer″
                  }
                },
                ″required″: [
                  ″label″,
                  ″x″,
                  ″y″
                ]
              }
            }
          },
          ″required″: [
            ″x_title″,
            ″y_title″,
            ″points″
          ]
        },
        ″A_text_with_inline_latex″: {
          ″type″: ″string″,
          ″description″: ″Answer A written in text with inline
LaTeX.″
        },
        ″A_explanation_text_with_inline_latex″: {
          ″type″: ″string″,
          ″description″: ″Explanation for answer A, explaining why
it is either correct or incorrect, written in text with inline LaTeX.″
        },
        ″A_correct″: {
          ″type″: ″boolean″,
          ″description″: ″Indicates whether answer A is the correct
answer.″
        },
        ″B_text_with_inline_latex″: {
          ″type″: ″string″,
          ″description″: ″Answer B written in text with inline
LaTeX.″
        },
        ″B_explanation_text_with_inline_latex″: {
          ″type″: ″string″,
          ″description″: ″Explanation for answer B, explaining why
it is either correct or incorrect, written in text with inline LaTex.″
        },
        ″B_correct″: {
          ″type″: ″boolean″,
          ″description″: ″Indicates whether answer B is the correct
answer.″
        },
        ″C_text_with_inline_latex″: {
          ″type″: ″string″,
          ″description″: ″Answer C written in text with inline
LaTeX.″
        },
        ″C_explanation_text_with_inline_latex″: {
          ″type″: ″string″,
          ″description″: ″Explanation for answer C, explaining why
it is either correct or incorrect, written in text with inline LaTex.″
        },
        ″C_correct″: {
          ″type″: ″boolean″,
          ″description″: ″Indicates whether answer C is the correct
answer.″
        },
        ″D_text_with_inline_latex″: {
          ″type″: ″string″,
          ″description″: ″Answer D written in text with inline
LaTeX.″
        },
        ″D_explanation_text_with_inline_latex″: {
          ″type″: ″string″,
          ″description″: ″Explanation for answer D, explaining why
it is either correct or incorrect, written in text with inline LaTeX.″
        },
        ″D_correct″: {
          ″type″: ″boolean″,
          ″description″: ″Indicates whether answer D is the correct
  answer.″
        }
      },
      ″required″: [
        ″question_text_with_inline_latex″,
        ″stimulus_description″,
        ″A_text_with_inline_latex″,
        ″A_explanation_text_with_inline_latex″,
        ″A_correct″,
        ″B_text_with_inline_latex″,
        ″B_explanation_text_with_inline_latex″,
        ″B_correct″,
        ″C_text_with_inline_latex″,
        ″C_explanation_text_with_inline_latex″,
        ″C_correct″,
        ″D_text_with_inline_latex″,
        ″D_explanation_text_with_inline_latex″,
        ″D_correct″
      ]
    }
  }
```

The generatMCQ4Choice function creates a mathematics MCQ for the user, incorporating both the question and a potential visual stimulus. The multiagent AI engine 110 provides the question text, formatted with inline LaTeX, and describes the visual stimulus. The function then generates four answer choices, each accompanied by an explanation in text with inline LaTeX that clarifies whether the choice is correct or incorrect. For each answer choice (A, B, C, D), the multiagent AI engine 110 indicates if it is the correct one by setting a boolean value. The function requires all these elements to be provided to generate a complete MCQ, ready for the user to answer.

An exemplary prompt and function created by the generator assistant 112 to guide and constrain the validator assistant 114 is:

```
Context
- - - - - - - -
You are a Mathematics multiple-choice question (MCQ) correctness
checker. Your job is to use Code Interpreter to evaluate the objective
correctness of an MCQ passed in as input.
  Task
  - - - - - - - -
  1. Assume the visual stimulus described by the Stimulus
Description is given. If labels are not given in the Stimulus
Description, assume that the first stimulus in the outputted list will
be labeled “Figure 1”, the second will be named “Figure 2”, and so
forth.
  2. Use Code Interpreter to assess the correctness of the inputted
MCQ by checking whether it passes each and every one of the Objective
Correctness.
  3. Generate an accompanying explanation that details why the
question’s correctness was “True” or “False” along with a suggestion on
remedying the question's correctness.
  4. Output the generated MCQ correctness evaluation using the
functions. generate output tool following the Output Template.
  Rules
  - - - - - - - -
  * ALL Objective Correctness Metrics must be checked for the
question passed in as input.
  * If the MCQ fails ANY Objective Correctness Metrics, the output
in the “Correct” field should be set to “False.”
  * If the MCQ passes ALL Objective Correctness Metrics, the output
in the “Correct” field should be set to “True.”
  Objective Correctness Metrics :
  * The answer marked “correct: TRUE” in the JSON object is
objectively the mathematically correct answer to the MCQ
  * There is no ambiguity about the correctness of the correct
answer choice or the incorrectness of the incorrect answer choices
  * The answer choices only refer to the stimulus using the proper
labels.
  * All figures described by the stimulus MUST be used in the
question or answer choices
  * Only one answer choice is objectively the mathematically
correct answer to the MCQ.
  * Answer choices are distinguishable from each other and are NOT
mathematically equivalent.
  * Explanations for answer choices labeled “correct: TRUE” in JSON
correctly identify the answer choice as correct and explain how a
student can solve the question and arrive at the correct answer.
  * Explanations for answer choices labeled “correct: FALSE” in
JSON correctly identify the answer choice as incorrect and have no
mathematical errors in the explanation.
  * The question specifically asks for the correct answer choice.
  * Ensure the wording of the question does NOT leave room for
ambiguity.
  Output Template
  - - - - - - - -
  Correct: Indicate as a boolean whether the MCQ passed in as a
JSON input is objectively correct. Use Code Interpreter for this task.
Objective Correctness Metrics can be found below in Rules.
  Explanation: Explain why the multiple choice question was
objectively correct or broken. Broken question explanations should be
specific and elaborate on at least one failed Objective Correctness
Metric. Provide a suggestion to improve the broken question. Correct
question explanations should simply state: “Passed all Objective
Correctness Metrics.”
  Run Fail: Whether or not any system or technical errors occurred
```

The prompt instructs the multiagent AI engine 110 to act as a mathematics MCQs correctness checker, using a code interpreter to objectively evaluate the accuracy of an inputted MCQs. The multiagent AI engine 110 task involves assessing the MCQs against a set of specific objective correctness metrics. The multiagent AI engine 110 should assume that any visual stimulus described by the stimulus description is provided, and if labels are not specified, the multiagent AI engine 110 should label the stimuli sequentially as “FIG. 1,” “FIG. 2,” etc.

The multiagent AI engine 110 must carefully check if the MCQs meet all the objective correctness metrics, such as ensuring the correct answer is mathematically accurate, there is no ambiguity, all stimulus figures are used appropriately, and the explanations are mathematically sound. If the MCQ fails any of these metrics, the multiagent AI engine 110 should mark the question as incorrect and provide a detailed explanation of the issue, along with a suggestion for correcting the question. If the MCQ passes all metrics, simply state that it “passed all Objective Correctness Metrics.” Finally, you will output the evaluation using a specified template, indicating whether the MCQ is correct and explaining your reasoning.

### Function:

```
  {
    “name”: “generate_output”,
    “description”: “Determine if an MCQ inputted
is objectively correct”,
    “parameters”: {
      “type”: “object”,
      “properties”: {
        “correct”: {
          “type”: “boolean”,
          “description”: “Whether the MCQ is objectively
correct or broken”
        },
        “explanation”: {
          “type”: “string”,
          “description”: “Explanation of why the MCQ
is objectively correct or broken”
        },
        “run fail”: {
          “type”: “boolean”,
          “description”: “Whether any system or
technical errors occurred”
        }
      },
      “required”: [
        “correct”,
        “explanation”,
        “run fail”
      ],
      “additionalProperties”: false
    }
  }
```

The ‘generate_output’ function determines whether an MCQ is objectively correct or flawed. The ‘generate_output’ function evaluates the MCQ based on predefined criteria, which include mathematical accuracy, clarity, and proper use of any visual stimuli. The function requires the multiagent AI engine 110 to input three key parameters: whether the MCQ is correct, an explanation detailing why the MCQ is either correct or broken, and whether any system or technical errors occurred during the evaluation. The ‘generate_output’ function then outputs a structured assessment, indicating the MCQ's correctness, providing an explanation, and noting any errors encountered in the process. This ensures that the MCQs are thoroughly evaluated and that any issues are communicated clearly.

An exemplary prompt and function created by the generator assistant 112 to guide and constrain the preprocessor 116:

```
  Context
  - - - - - - - -
  You are a professional LaTex formatter. You will be given a
mathematics Multiple Choice Question (MCQ) in text format with inline
LaTex. Your task is to correctly parse all special characters and all
mathematical expressions so that the text renders in LaTex without
errors.
  Task
  - - - - - - - -
  1. Identify all mathematical expressions, operations, and special
characters in the input text.
  2. Ensure all mathematical expressions, operations, and special
characters are written in text format with inline LaTex notation.
Ensure all mathematical expressions are delimited in dollar signs.
  3. Ensure all tables and lists are correctly formatted in LaTeX.
  4. Ensure all LaTex Special Characters are escaped correctly with
a backslash to render the Output in LaTeX.
  LaTeX Special Characters: #, $, %, &, |, \,?, _, {, }, ~, <, >.
  Rules
  - - - - - - - -
  * All mathematical equations and expressions MUST be delimited by
dollar signs.
  * All text must be correctly parsed to render in LaTex correctly.
  * Non-mathematical text should NOT be specially parsed or
delimited.
  * Fractions must be denoted using the command “\frac { } { }”.
  * Non-ASCII arithmetic operators must be replaced with the
appropriate LaTex command. For example: “$5\div 2 = 2.5$”, “$4\times
3 = 12$”, “$2\cdot f (5) = 20$”.
  * Standalone numerical characters should NOT be delimited in
dollar signs. Only numerical characters which are part of a
mathematical operation or expression should be delimited as part of the
overall expression.
  * Dollar signs should NOT be escaped with a backslash if they are
used as delimiters.
  * Dollar signs must be denoted using the token “DOLLAR SIGN” if
they are used to denote currency.
  * Underscores must be denoted using the command “\textunderscore”
unless it is used to indicate a subscript. For example: “Find the next
number? 1, 2, 3, \textunderscore”, “$5 =\
textunderscore\textunderscore\textunderscore + 2$”, “Find $x 2 = x 1 +
3$, where $x 1 = 4$”.
  * Carets should NOT be escaped with a backslash if they are used
to write superscript text or to denote exponentiation.
  * Backslashes and braces should NOT be escaped if they are used
as part of a LaTex command.
  * Pipe symbols must be delimited in dollar signs and should NOT
be escaped with a backslash.
  * Smaller than and Greater than symbols must be delimited in
dollar signs and should NOT be escaped with a backslash.
  Output Template
  - - - - - - - -
  Question: The generated MCQ in proper LaTex formatting.
  A: The first answer choice, along with its respective explanation
and flag for correctness. All in proper LaTeX formatting.
  B: The second answer choice, along with its respective
explanation and flag for correctness. All in proper LaTex formatting.
  C: The third answer choice, along with its respective explanation
and flag for correctness. All in proper LaTex formatting.
  D: The fourth answer choice, along with its respective
explanation and flag for correctness. All in proper LaTex formatting
```

The prompt assigns the multi-agent AI engine 110 the role of a professional LaTeX formatter, with the responsibility of converting a mathematics MCQ from plain text into properly formatted LaTeX. The multiagent AI engine110 primary task is to identify and correctly format all mathematical expressions, operations, and special characters in the input text so that the final output is rendered correctly in LaTeX.

The multiagent AI engine 110 ensure that every mathematical expression is enclosed in dollar signs, denoting LaTeX's inline math mode. Special characters, such as #, $, %, &, |, \, \hat{ }, _, {, }, ~, <, and >, need to be properly escaped with a backslash when used in regular text, except when they serve a mathematical or LaTeX-specific function.

Fractions should be formatted using the \frac { } { } command, and all arithmetic operators should be replaced with their corresponding LaTeX commands, such as \div, \times, and \cdot. Numerical characters should only be enclosed in dollar signs if they are part of a mathematical operation or expression. Currency dollar signs should be replaced with the token DOLLAR_SIGN to avoid confusion with LaTeX's math mode delimiter.

The prompt also instructs the multiagent AI engine 110 on how to handle specific LaTeX formatting issues, such as using the \textunderscorecommand for standalone underscores unless they are used for subscripts. Carets and backslashes should be used appropriately without unnecessary escaping if they denote superscripts, exponentiation, or LaTeX commands.

The multiagent AI engine 110 output should follow a structured template that includes the formatted question, answer choices, explanations, and correctness flags, all properly formatted in LaTeX. This ensures that the final content is correctly rendered and free of errors, maintaining clarity and precision in the presentation of mathematical content.

### Function:

```
  {
    “name”: “parseMathExpressions 4Choice”,
    “description”: “Parse and format a Multiple-Choice Question
(MCQ) into LaTeX.”,
    “parameters”: {
      “type”: “object”,
      “properties”: {
        “question”: {
          “type”: “object”,
          “properties”: {
            “text_with_inline_latex”: {
              “type”: “string”,
              “description”: “The multiple-choice question
rewritten with LaTeX mathematical expressions.”
            }
          },
          “required”: [“text_with_inline_latex”]
        },
        “A” : {
          “type”: “object”,
          “properties”: {
            “answer”: {
              “type”: “object”,
              “properties”: {
                “text_with_inline_latex”: {
                  “type”: “string”,
                  “description”: “Answer A rewritten with LaTeX
mathematical expressions.”
                }
              },
              “required”: [“text_with_inline_latex”]
          },
          “explanation”: {
            “type”: “object”,
            “properties”: {
              “text_with_inline_latex”: {
                “type”: “string”,
                “description”: “Explanation for answer A,
explaining why it is either correct or incorrect, rewritten with LaTeX
mathematical expressions.”
              }
            },
            “required”: [“text_with_inline_latex”]
          },
          “correct”: {
            “type”: “boolean”,
            “description”: “Indicates whether answer A is the
correct answer”
            }
          },
          “required”: [“answer”, “explanation”, “correct”]
        },
        “B”: {
          “type”: “object”,
          “properties”: {
            “answer”: {
              “type”: “object”,
              “properties”: {
                “text_with_inline_latex”: {
                  “type”: “string”,
                  “description”: “Answer B rewritten with LaTeX
mathematical expressions.”
                }
            },
            “required”: [“text_with_inline_latex”]
          },
          “explanation”: {
            “type”: “object”,
            “properties”: {
                “text_with_inline_latex”: {
                  “type”: “string”,
                  “description”: “Explanation for answer B,
explaining why it is either correct or incorrect, rewritten with LaTeX
mathematical expressions.”
                }
              },
              “required”: [“text_with_inline_latex”]
            },
            “correct”: {
              “type”: “boolean”,
              “description”: “Indicates whether answer B is the
correct answer”
            }
          },
          “required”: [“answer”, “explanation”, “correct”]
        },
        “C”: {
          “type”: “object”,
          “properties”: {
            “answer”: {
              “type”: “object”,
              “properties”: {
                “text_with_inline_latex”: {
                  “type”: “string”,
                  “description”: “Answer C rewritten with LaTeX
mathematical expressions.”
            }
              },
              “required”: [“text_with_inline_latex”]
            },
            “explanation”: {
              “type”: “object”,
              “properties”: {
                “text_with_inline_latex”: {
                  “type”: “string”,
                  “description”: “Explanation for answer C,
explaining why it is either correct or incorrect, rewritten with LaTeX
mathematical expressions.”
                }
              },
                “required”: [“text_with_inline_latex”]
            },
            “correct”: {
                “type”: “boolean”,
                “description”: “Indicates whether answer C is the
correct answer”
            }
          },
          “required”: [“answer”, “explanation”, “correct”]
        },
        “D”: {
          “type”: “object”,
          “properties”: {
            “answer”: {
                “type”: “object”,
                “properties”: {
                  “text_with_inline_latex”: {
                    “type”: “string”,
                    “description”: “Answer D rewritten
with LaTeX mathematical expressions.”
                  }
                },
                “required”: [“text_with_inline_latex”]
            },
            “explanation”: {
                “type”: “object”,
                “properties”: {
                  “text_with_inline_latex”: {
                    “type”: “string”,
                    “description”: “Explanation for answer D,
explaining why it is either correct or incorrect, rewritten with LaTeX
mathematical expressions.”
                  }
                },
                “required”: [“text_with_inline_latex”]
            },
            “correct”: {
                “type”: “boolean”,
              “description”: “Indicates whether answer D is the
correct answer”
            }
          },
          “required”: [“answer”, “explanation”, “correct”]
        }
      },
      “required”: [“question”, “A”, “B”, “C”, “D”]
    }
  }
```

The ‘parseMathExpressions4Choice’ function is designed to convert a mathematics MCQ into LaTeX format, ensuring that all mathematical expressions, operations, and special characters are properly parsed and formatted. The ‘parseMathExpressions4Choice’ function takes an input JSON object that includes the MCQ text, along with four answer choices labeled A, B, C, and D. Each answer choice is accompanied by an explanation and a flag indicating whether choice is correct.

The ‘parseMathExpressions4Choice’ function processes each part of the MCQ by focusing on the text content, specifically the question itself, each answer option, and the corresponding explanations. The ‘parseMathExpressions4Choice’ function rewrites all mathematical expressions within these text components using LaTeX inline notation, ensuring that they are properly enclosed in dollar signs to denote math mode in LaTeX. Additionally, any special characters used in LaTeX, such as underscores, carets, and backslashes, are handled according to LaTeX syntax rules.

For each answer choice (A, B, C, and D), the ‘parseMathExpressions4Choice’ function ensures that the text is correctly formatted with LaTeX commands and that the explanation provided is also properly rewritten in LaTeX. The ‘parseMathExpressions4Choice’ function also retains a Boolean flag for each answer, indicating whether that particular choice is correct. An exemplary prompt and function created by the generator assistant 112 to guide and constrain the validator battery 122 for multiple correct answers is given below:

```
  Context
  - - - - - - - -
  You are a Mathematics Multiple-Choice Question (MCQ) correctness
checker. Your job is to assess an MCQ and its Stimulus for
mathematical correctness and semantic validity. Write and run code
every step of the way.
  Task
  - - - - - - - -
  1. Use the Stimulus Type Specifications and Code Interpreter to
interpret the Question and its accompanying Stimulus.
  2. Write and run code to solve the MCQ.
  3. Write and run code to evaluate all Assessments.
  Assessments
  - - - - - - - -
  1. The answer choice marked as Correct: “True” in the MCQ is the
mathematically correct answer to the MCQ.
  2. There is exactly one answer choice marked as Correct: “True”
in the MCQ.
  3. All answer choices marked as Correct: “False” in the MCQ must
NOT be mathematically correct answers to the MCQ. Calculate this to
verify by writing and running code. Do NOT simply rely on the truth
value provided in the Correct field.
  Output Template
  - - - - - - - -
  Passed: A boolean indicating whether all assessments passed
(true) or any failed (false).
```

In the above mentioned prompt, multiagent AI engine 110 the role of a mathematics MCQ correctness checker. The multiagent AI engine 110 task involves evaluating an MCQ and its accompanying stimulus to ensure both mathematical correctness and semantic validity. To achieve this, the multiagent AI engine 110 will follow a series of steps using a code interpreter to assist in the evaluation.

Firstly, the multiagent AI engine 110 needs to use the stimulus type specifications to interpret the provided MCQ and its stimulus. This involves understanding how the stimulus should be applied to the question and ensuring that any visual or contextual elements are correctly integrated into the problem-solving process.

Next, multiagent AI engine 110 will write and run code to solve the MCQ. The step ensures that the mathematical problem posed by the question is addressed correctly and that the solution aligns with the given answer choices.

Following this, the multiagent AI engine 110 will write and run additional code to evaluate all assessments related to the MCQ.

Finally, the multiagent AI engine 110 will produce an output indicating whether all assessments passed or if any failed. This boolean output will reflect the overall correctness and validity of the MCQ and its associated components.

An exemplary prompt and function created by the generator assistant 112 to guide and constrain the validator battery 122 for a fraction answer is given below:

```
  Context
  - - - - - - - -
  You are a Mathematics Multiple-Choice Question (MCQ) correctness
checker. Your job is to assess an MCQ
for mathematical correctness and
semantic validity. Use the Code Interpreter tool to write and run code
every step of the way.
  Task
  - - - - - - - -
  1. Assess that the answer choice marked as “true” in the MCQ is
mathematically correct.
  2. Use code interpreter to simplify all answer choices to decimal
form and ensure all these decimals are unique.
  Rules
  - - - - - - - -
  * Reject questions with answer choices like “none of the above”
or “all of the above.”
  * Reject questions when the correct answer option is missing an
explanation.
  * Reject questions with answer choices with equivalent answers.
For example, reject the answer choices 2/4 and 0.5 if 1/2 already
exists
  Output Template
  - - - - - - - -
  Passed: A boolean indicating whether all assessments passed
(true) or any failed (false).
```

The above mentioned prompt evaluates MCQ to ensure mathematical correctness and semantic validity. The multiagent AI engine 110 will first verify whether the answer choice marked as “true” is indeed mathematically correct. Then, using the code interpreter to simplify all answer choices to decimal form and ensure all these decimals are unique. Converting answer choices to decimal prevents equivalent answers from being listed as different choices, such as 2/4, 0.5, or ½, which represent the same value.

Certain types of questions should be rejected by the multiagent AI engine 110. If the MCQ includes answer options like “none of the above” or “all of the above,” then the MCQ is invalid. The correct answer choice should also have a clear mathematical explanation, and all answer options should be distinct when converted to decimal form. If two or more options are equivalent, the MCQ fails the assessment. Finally, the output should include a boolean value indicating whether the MCQ passed or failed all checks.

An exemplary prompt and function created by the generator assistant 112 to guide and constrain the validator battery 122 for plotting points is given below:

```
  Context
  - - - - - - - -
  You are a Mathematics Multiple-Choice Question (MCQ) correctness
checker. Your job is to assess an MCQ and its Stimulus for mathematical
correctness and semantic validity. The Stimulus will be described in
stimulus description. ALWAYS show your work for each task’s answer, 1
by 1. Use the output assessment function to output at the end of all
tasks or if a task fails.
  There are 3 sections to the MCQ, the question, the answers, and
the stimulus.
  Task
  - - - - - - - -
  1. Verify if the question text includes both the points (values)
and their corresponding frequencies.
  2. Assess that the count of each point correlates with the
correct answer and that it is marked correctly.
  Output Template
  - - - - - - - -
  Passed: A boolean indicating whether all assessments passed
(true) or any failed (false).
```

The above mentioned prompt assigns the role of the Mathematics MCQ correctness checker for the multiagent AI engine 110. The primary responsibility of the multiagent AI engine 110 is to evaluate both an MCQ and its associated stimulus for mathematical accuracy and semantic validity. The multiagent AI engine 110 must show their work for each task's answer individually. The multiagent AI engine 110 is instructed to use an output_assessment function to provide the final output after completing all tasks or if a task fails. The MCQ consists of three main sections: the question, the answers, and the stimulus.

The multiagent AI engine 110 is assigned two specific tasks: The multiagent AI engine 110 must verify if the question text includes both the points (values) and their corresponding frequencies, and the multiagent AI engine 110 needs to assess whether the count of each point correlates with the correct answer and confirm marked correctly. For the output, the prompt instructs the multiagent AI engine 110 to use a template that includes a “passed” field. This field is a boolean value indicating whether all assessments passed (true) or if any failed (false).

An exemplary prompt and function created by the generator assistant 112 to guide and constrain the validator battery 122 for consistent answer choice is given below:

```
Context
- - - - - - - -
You are a Mathematics Multiple-Choice Question (MCQ) quality
control expert. Your job is to assess an MCQ to ensure the correct
answer is not indicated by formatting clues.
  Task
  - - - - - - - -
  1. Use the Stimulus Type Specifications to interpret the MCQ and
its accompanying Stimulus.
  2. Assess that the answer choice marked as “true” in the MCQ does
not have any formatting clues to indicate it is the correct answer.
Formatting clues may include, but are not limited to, the presence or
absence of commas, words or phrases, or punctuation marks.
  Output Template
  - - - - - - - -
  Passed: A boolean indicating whether all assessments passed
(true) or any failed (false).
```

The above mentioned prompt assigns the multiagent AI engine 110 role of a Mathematics MCQ quality control expert and ensures the correct answer is not indicated by formatting clues. The multiagent AI engine 110 is tasked with two specific duties, first to use the stimulus type specifications to interpret the MCQ and its accompanying stimulus. Second, to assess the answer choice marked as “true” in the MCQ does not have any formatting clues to indicate the answer is the correct answer. Formatting clues may include, but are not limited to, the presence or absence of commas, words or phrases, or punctuation marks.

For the output, the multiagent AI engine 110 needs to use a template that includes a “passed” field. This field is a boolean value indicating whether all assessments passed (true) or if any failed (false). A passing assessment means that no formatting clues were found that might give away the correct answer.

An exemplary prompt and function created by the generator assistant 112 to guide and constrain the validator battery 122 for complex decimals is given below:

```
Context
- - - - - - - -
You are a Mathematics Multiple-Choice Question (MCQ) correctness
checker. Your job is to assess an MCQ and its Stimulus for
mathematical correctness and semantic validity. Write and run code
every step of the way.
  Assessments
  - - - - - - - -
  1. Fail the assessment if any decimal does not end
in .25, .33, .5, .66, or .75.
  2. Fail the assessment if any decimals go to more than two places
(hundredths place).
  Output Template
  - - - - - - - -
  Passed: A boolean indicating whether all assessments passed
(true) or any failed (false).
```

The above mentioned prompt assigns the role of a Mathematics MCQ correctness checker for the multiagent AI engine 110. The multiagent AI engine 110 primary responsibility is to evaluate both MCQ and its associated stimulus for mathematical accuracy and semantic validity.

The multiagent AI engine 110 need to perform two specific assessments. First, fail the assessment if any decimal does not end in 0.25, 0.33, 0.5, 0.66, or 0.75. and fail the assessment if any decimals go to more than two places (hundredths place). For the output, the multiagent AI engine 110 uses boolean indicating whether all assessments passed (true) or any failed (false)

An exemplary prompt and function created by the generator assistant 112 to guide and constrain the validator battery 122 is given below:

```
  {
    “name”: “check math_mcq”,
    “description”: “Determine whether the MCQ passes all
assessments or not”,
    “parameters”: {
      “type”: “object”,
      “properties”: {
        “passed”: {
        “type”: “boolean”,
        “description”: “Denotes whether the MCQ passed all
assessments (true) or did not pass all assessments (false)”
      }
    },
    “required”: [
      “passed”
    ]
  }
}
```

The ‘check_math_mcq’ function is designed to determine whether a given mathematics MCQ has passed all required assessments. The ‘check_math_mcq’ function takes a single boolean parameter, ‘passed’, which indicates whether the MCQ successfully meets all evaluation criteria. If the value of ‘passed’ is ‘true’, means that the MCQ has been validated as correct and has passed all assessments. Conversely, if the value is ‘false’, signifies that the MCQ did not meet one or more of the required criteria. The ‘check_math_mcq’ function provides a straight forward means of summarizing the results of a detailed assessment process to determine the overall correctness and validity of the MCQ.

In operation 208, the generator assistant 112 generates a first draft of at least one MCQ, based on the inputs received from the content generation system 104. The generator assistant 112, part of the multiagent AI engine 110, creates MCQs based on curriculum inputs defined in the data model 106. Each standard is mapped to a specific generator assistant 112, which is responsible for generating questions for that standard. Some of the generator assistant 112 focus on one or more standards for MCQ generation. The generator assistant 112 utilizes OpenAI assistance with a temperature setting of 1, to generate the MCQs and outputs them in JSON format.

An exemplary prompt and function created by the generator assistant 112 to guide and constrain the generator assistant 112 in JSON format is given below:

```
  {
    “question text with inline latex”: “Which point is at $ (1, −2) $
on the coordinate plane?”,
    “A text with inline latex”: “Point A”,
    “A explanation text with inline latex”: “Point A is located at
$ (8, −1) $, which does not match the coordinates given.”,
    “A correct”: false,
    “B text with inline latex”: “Point B”,
    “B explanation text with inline latex”: “Point B is located at
$ (−1, 10) $, which does not match the coordinates given.”,
    “B correct”: false,
    “C text with inline latex”: “Point C”,
    “C_explanation_text_with_inline latex”: “Point C is located at
$ (1, −2) $, which matches the coordinates given.”,
    “C correct”: true,
    “D text with inline latex”: “Point D”,
    “D explanation text with inline latex”: “Point D is located at
$ (1, 4) $, which does not match the coordinates given.”,
    “D correct”: false,
    “stimulus description”: {
      “x_title”: “X”,
      “y_title”: “Y”,
      “points”: [
        { “label”: “A”, “x”: 8, “y”: −1 },
        { “label”: “B”, “x”: −1, “y”: 10 },
        { “label”: “C”, “x”: 1, “y”: −2 },
        { “label”: “D”, “x”: 1, “y”: 4 },
      ]
    }
  }
```

In operation 210, the general validator assistant 114 validates the generated MCQ for correctness and alignment with the educational standards, wherein the question failing validation step is regenerated by the generator assistant 112 for one or more pre-defined cycles. Where in the general validator assistant 114 uses prompts from the content generation system 104 in the OpenAI assistance with a temperature setting of 1, for the validation of the question generated by the generator assistant 112

If the general validator assistant 114 determines the MCQ has correctness issues, “correct” is set to false, and the “explanation” will provide details for what is wrong with the MCQ.

For example,

```
{
  “correct”: true,
  “explanation”: “Passed all Objective Correctness Metrics.”,
  “run fail”: false
```

The general validator assistant 114 output constructs the appropriate follow-up message to send back to the generator assistant 112. The table below shows the possible message structures and their corresponding use cases.

| Name | When to use | Message |
|---|---|---|
| Default | If the function-calling | Use the function given to |
| Follow-up | tool was not used in | format the output in proper |
| Message | the run | JSON |
| Default | If parsing the response | The question might be broken, |
| Correction | fails, or the run fails | use code interpreter to verify |
| Message | in general | the mathematical validity and |
| | | fix any errors. Output in the |
| | | same format. |
| Specified | If “correct” == false | Given the following reasoning, |
| Correction | | fix the generated question and |
| Message | | output in the same format: |
| | | ‘{insert explanation here}’ |

In operation 212, the preprocessing 116 validates the MCQs for completeness, formatting, and context-related modifications. The pre-processing 116 receives the prompt from the content generation system 104 and completes the operations with OpenAI assistance with a temperature setting of 1. The pre-processing 116, which converts the MCQ from JSON into a LaTeX-formatted string. This conversion allows the question to be displayed properly to the user.

For example:

```
  Question: Which point is at $ (1, −2) $ on the coordinate plane?\\
  \\
  Option A: \\
  Answer: Point A\\
  Correct: False\\
  \\
  Option B: \\
  Answer: Point B\\
  Correct: False\\
  \\
  Option C: \\
  Answer: Point C\\
  Correct: True\\
  \\
  Option D: \\
  Answer: Point D\\
  Correct: False\\
  \\
  Explanation: Point C is located at $ (1, −2) $, which matches the
coordinates given.
```

In operation 214, perform one or more additional validation checks 118 on the MCQ for identification of any issues, and the MCQ is discarded if MCQ fails on at least one of the additional validation checks 118. The additional validation checks 118 uses the prompt or function and data from the content generation system 104 and the data model 106, respectively, for verification of the MCQ question generated by the generator assistant 112. The additional validation checks 118 include the code-level validation 120, the validator battery 122, and the post-processing 124. The code-level validation 120 involves programmatically checking for issues such as invalid JSON formatting and values outside the acceptable range for the CCSS. If any issues are detected during this validation process, the code-level validation 120 discards the question and restarts the MCQ generation process with the generator assistant 112. This ensures that only valid and properly formatted questions proceed to the validator battery 122 step. The validator agent 122 comprehensively evaluates each MCQ using a series of OpenAI assistants, each tailored to a specific standard. The validator agent 122 performs both qualitative and quantitative checks on the generated question, ensuring its validity and alignment with the relevant educational standards. Only MCQs that pass all validators are deemed suitable for output. The postprocessing 124 step includes optional functions that address predictable static issues in MCQs, which can be automatically corrected programmatically. The stimulus generation 126 generates stimulus after completion of the MCQ generation, and the output combined is given to the user interface 102.

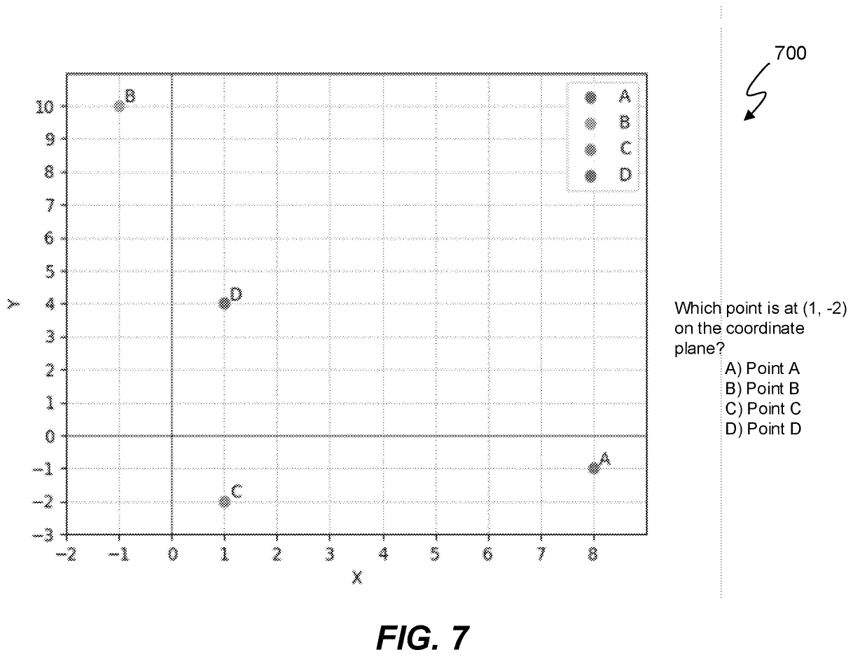

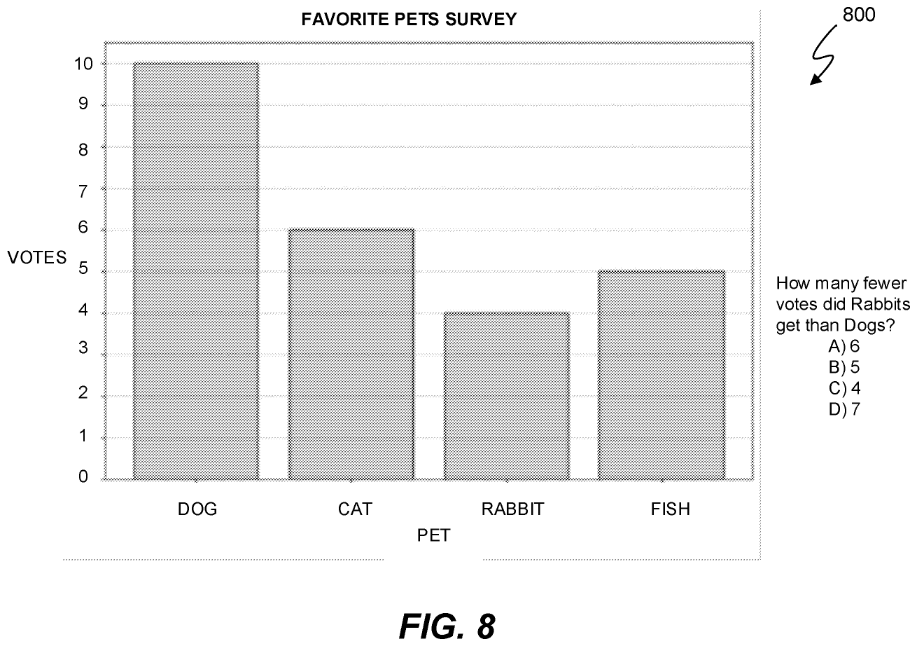

FIGS. 7 and 8 depict examples for the final output given to the user interface 102.

Pseudo code used to practice the disclosure is given below:

```
  function generateMCQ (dataModel):
    # Get the necessary inputs from the data model
    inputs = getInputs FromDataModel (dataModel)
    # Generate an initial question using the Generator Assistant
    question = generateQuestion (inputs)
    # Check if the question is valid
    validationAttempts = 0
    while not isQuestionValid (question):
      # If the question is invalid, get feedback from the
Validator Assistant
      feedback = getValidatorFeedback (question)
      # Add the feedback to the inputs and regenerate
the question
      inputs.append ( feedback)
      question = generateQuestion (inputs)
      validationAttempts += 1
      # If the question fails validation 3 times,
stop the process
      if validationAttempts >= 3:
        return None
    # Format the question and perform additional checks
    question = formatQuestion (question)
    if not passesAdditionalChecks (question):
      return None
    # If the question requires a stimulus, generate one
    if requiresStimulus (dataModel):
      stimulus = generateStimulus (question)
      question.append ( stimulus )
    # Return the final generated question
    return question
```

The pseudocode describes a function called ‘generateMCQ’ that generates a multiple-choice question (MCQ) based on the provided data model 106. The ‘generateMCQ’ function first extracts necessary inputs from the data model 106 using a ‘getInputsFromDataModel, function. The ‘generateMCQ’ function then generates an initial question with the help of the generator assistant 112 by passing these inputs to a ‘generateQuestion’ function. After generating the question, the ‘generateMCQ’ function checks question validity through an ‘isQuestion Valid’ function. If the question is invalid, the question enters a loop where it collects feedback from the general validator assistant 114 using the ‘getValidatorFeedback’,function. The feedback is appended to the inputs, and the question is regenerated. The loop continues until the question passes validation or has failed three times, in which case the ‘getValidatorFeedback’ function returns ‘None’ to indicate failure.

If the question is valid, the ‘generateMCQ’ function formats it using ‘formatQuestion’ and performs additional checks with ‘passesAdditionalChecks’. If the question fails these checks, the function returns none. If the data model 106 indicates that the question requires a stimulus (an additional element such as a text or image), the ‘generateMCQ’ function generates one with generate stimulus and appends it to the question. Finally, the ‘generateMCQ’ function returns the completed MCQ.

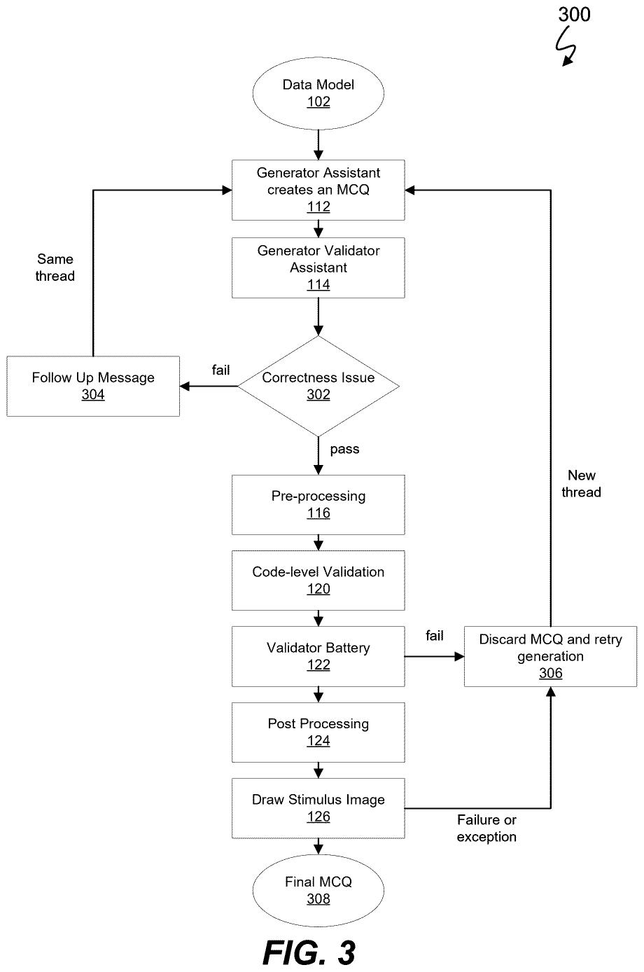

FIG. 3 depicts a functional block diagram 300 for the MCQ generation and validation method, which is an embodiment of the MCQ generation and validation method of FIG. 2.

The generator assistant 112 creates MCQs based on curriculum inputs defined in the data model 102. The generator assistant 112 maps each standard to a specific the generator assistant 112 responsible for creating questions for that standard. Some of the generator assistant 112 cover a single standard, while others handle a set of standards. This is a scalable process that accommodates any number of the generator assistant 112.

The general validator assistant 114, assesses the output from the generator assistant 112 based on basic correctness metrics. The general validator assistant 114 uses the generator assistant 112 output to construct a follow-up message 304, which is sent back to the generator assistant 112. The back-and-forth follow-up message 304 communication between the generator assistant 112 and the general validator assistant 114 continues until the MCQ either passes or fails 302 three times.

The preprocessing 116 converts the MCQ from JSON into a LaTeX-formatted string, ensuring the question is displayed correctly to the user.

The code-level validation 120 involves programmatically checking for issues such as invalid JSON formatting and values outside the acceptable range for the CCSS. If any issues are detected during this validation process, the code-level validation 120 discards the question and restarts the MCQ generation process with the generator assistant 112 through discard MCQ and retry generation 306.

The validator agent 122 comprehensively evaluates each MCQ. The validator agent 122 performs both qualitative and quantitative checks on the generated question, ensuring its validity and alignment with the relevant educational standards. Only MCQs that pass all validators are deemed suitable for output, or the MCQ will move to the discard MCQ and retry generation 306.

The post-processing 124 step includes optional functions that address predictable static issues in MCQs, which can be automatically corrected programmatically.

The stimulus generation 126 creates a stimulus image and give into a final MCQ module 308. If the stimulus generation 126 fails, then stimulus generation 126 makes to the discard MCQ and retry generation 306.

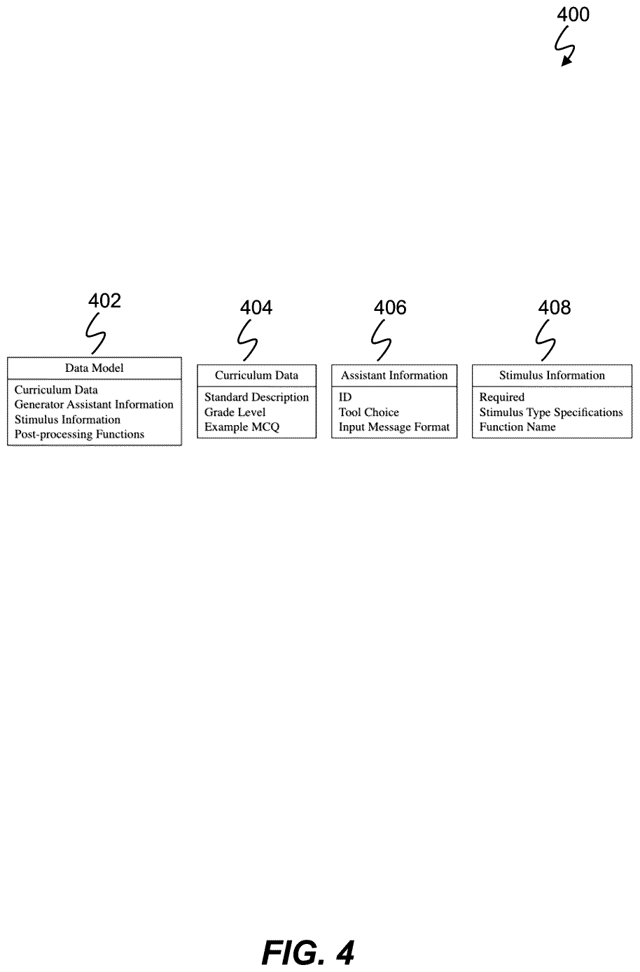

FIG. 4 depicts a data structure 400 for the MCQ generation and validation method 200. The data structure includes:

Data model 402, which represents the overall structure and contains sub-components such as curriculum data, generator assistant information, stimulus information, and post-processing functions. Each sub-component stores relevant information required for processing MCQs.

Curriculum data 404 holds details about the educational standards. The curriculum data 404 includes the standard description, grade level, and example MCQs. The curriculum data 404 is crucial for aligning generated questions with specific curriculum standards.

Assistant information 406 stores information about the generator assistant 112. The assistant information 406 includes the assistant's ID, the choice of tools, and the input message format required for processing.

The stimulus information 408 defines the details needed for the stimulus used in the MCQs. The stimulus information 408 specifies whether a stimulus is required, the type of stimulus, and the function name associated with processing the stimulus.

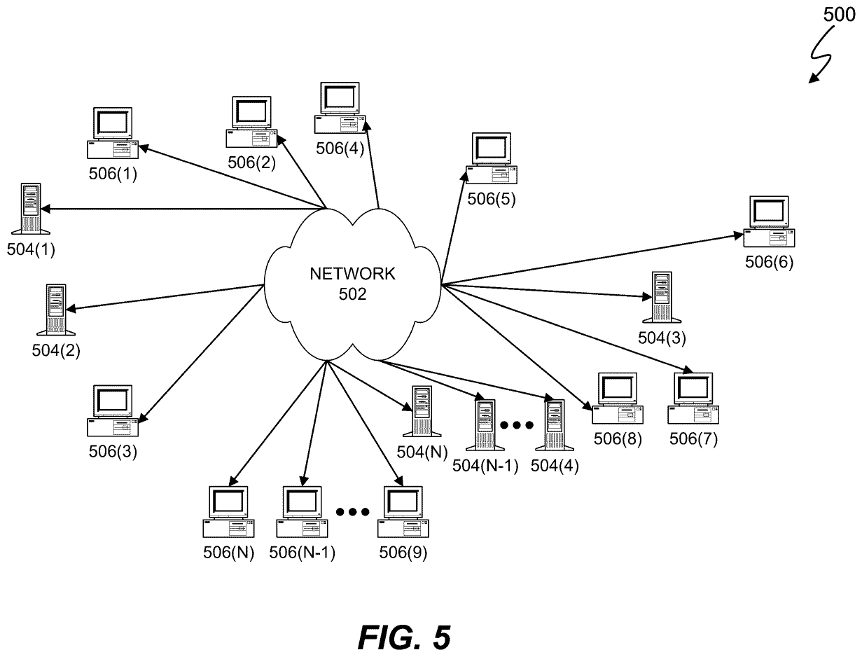

FIG. 5 is a block diagram illustrating a network environment in which a MCQ generation and validation system 100 and MCQ generation and validation method 200 may be practiced. Network 502 (e.g. a private wide area network (WAN) or the Internet) includes a number of networked server computer systems 504(1)-(N) that are accessible by client computer systems 506(1)-(N), where N is the number of server computer systems connected to the network. Communication between client computer systems 506(1)-(N) and server computer systems 504(1)-(N) typically occurs over a network, such as a public switched telephone network over asynchronous digital subscriber line (ADSL) telephone lines or high-bandwidth trunks, for example communications channels providing T1 or OC3 service. Client computer systems 506(1)-(N) typically access server computer systems 504(1)-(N) through a service provider, such as an internet service provider (“ISP”) by executing application specific software, commonly referred to as a browser, on one of client computer systems 506(1)-(N).

Client computer systems 506(1)-(N) and/or server computer systems 504(1)-(N) are specialized computer programmed to improve conventional computer systems to implement and utilize the MCQ generation and validation system 100 and MCQ generation and validation method 200. The type of computer system that can be specially programmed to implement and utilize the MCQ generation and validation system 100 and MCQ generation and validation method 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the MCQ generation and validation system 100 and MCQ generation and validation method 200 can be implemented using code stored in a tangible, non-transient computer readable medium and executed by one or more processors. In at least one embodiment, the MCQ generation and validation system 100 and MCQ generation and validation method 200 can be implemented completely in hardware using, for example, logic circuits and other circuits including field programmable gate arrays.

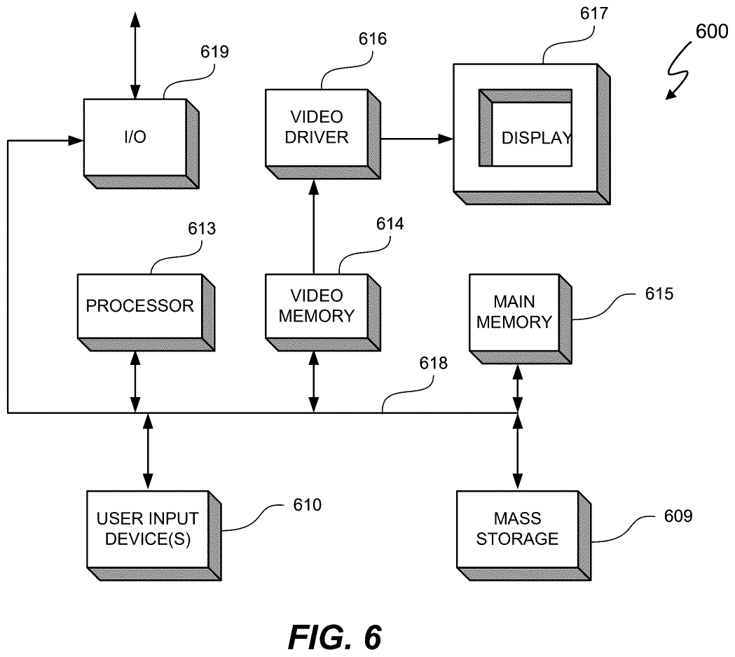

Embodiments of the MCQ generation and validation system 100 and MCQ generation and validation method 200 can be implemented on a computer system such as a special-purpose, special-programmed computer 600 illustrated in FIG. 6. Input user device(s) 610, such as a keyboard and/or mouse, are coupled to a bi-directional system bus 618. The input user device(s) 610 are for introducing user input to the computer system and communicating that user input to processor 613. The computer system of FIG. 6 generally also includes a non-transitory video memory 614, non-transitory main memory 615, and non-transitory mass storage 609, all coupled to bi-directional system bus 618 along with input user device(s) 610 and processor 613. The mass storage 609 may include both fixed and removable media, such as a hard drive, one or more CDs or DVDs, solid state memory including flash memory, and other available mass storage technology. Bus 618 may contain, for example, 32 of 64 address lines for addressing video memory 614 or main memory 615. The system bus 618 also includes, for example, an n-bit data bus for transferring DATA between and among the components, such as CPU 609, main memory 615, video memory 614 and mass storage 609, where “n” is, for example, 32 or 64. Alternatively, multiplex data/address lines may be used instead of separate data and address lines.

I/O device(s) 619 may provide connections to peripheral devices, such as a printer, and may also provide a direct connection to a remote server computer systems via a telephone link or to the Internet via an ISP. I/O device(s) 619 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 609, into main memory 615 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the display 617. Video amplifier 616 is well known in the art and may be implemented by any suitable means. This circuitry converts pixel DATA stored in video memory 614 to a raster signal suitable for use by display 617. Display 617 is a type of monitor suitable for displaying graphic images.

The computer system described above is for purposes of example only. The MCQ generation and validation system 100 and MCQ generation and validation method 200 may be implemented in any type of computer system or programming or processing environment. It is contemplated that the MCQ generation and validation system 100 and MCQ generation and validation method 200 might be run on a stand-alone computer system, such as the one described above. The MCQ generation and validation system 100 and MCQ generation and validation method 200 might also be run from a server computer systems system that can be accessed by a plurality of client computer systems interconnected over an intranet network. Finally, the MCQ generation and validation system 100 and MCQ generation and validation method 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding a multiagent AI engine to generate and validate one or more multiple-choice questions (MCQs) aligned with educational standards, the method comprises:
executing code using one or more processors of a computer system to cause the computer system to perform operations comprising:
providing access to a data model including educational standards, wherein the data model includes granular details related to the standards and sub-standards for generating multiple-choice questions (MCQs);
generating prompts to guide the multiagent AI engine in generating the multiple-choice questions (MCQs), wherein the prompts include one or more inputs received from the data model;
transferring the prompts to the multiagent AI engine configured to perform one or more operations comprising:
generating a first draft of at least one multiple choice question (MCQ), via a generator assistant, based on the inputs received from the data model;
validating the generated multiple choice question (MCQ) for correctness and alignment with the educational standards, wherein the question failing validation step is regenerated by the generator assistant for one or more pre-defined cycles;
pre-processing the validated multiple choice question (MCQs) for completeness, formatting, and context-related modifications; and
performing one or more additional validation checks on the multiple choice question (MCQ) for identification of any issues, wherein the additional validation checks ensure the question's validity and alignment with educational standards, and the MCQ is discarded if it fails on at least one of the additional checks.

2. The method of claim 1 further comprising running a code-level validation on the multiple-choice question (MCQ) after the pre-processing is done, wherein the code-level validation includes a programmatic check to resolve issues such as invalid JSON and values outside the acceptable range for the educational standards.

3. The method of claim 1 further comprising running a post-processing step after the additional validation checks are completed on the MCQ, wherein the post-processing step utilizes one or more functions to address any static issues in the validated multiple-choice question (MCQ) such as improper formatting of LaTex escape responses.

4. The method of claim 1 wherein the multiagent AI engine includes the generator agent for generating a first draft of the MCQ based on inputs received from the data model, a validator agent configured to assess the basic correctness of the generated MCQ, a formatting agent for making context-related modifications in the validated MCQ, and a validator battery to ensure validity and alignment of the MCQ with the educational standards.

5. The method of claim 1 wherein performing one or more additional validation checks on the multiple-choice question (MCQ) further comprises performing qualitative and quantitative checks on the generated question, wherein the additional validation checks are performed by a validator battery including a series of AI agents specifically tailored to ensure validity and accuracy of each question against relevant educational standards and sub-standard.

6. The method of claim 1 wherein the method of guiding a multiagent AI engine to generate and validate one or more multiple-choice questions (MCQs) aligned with educational standards further comprises:
providing details related to sub-standards under each standard in the data model, wherein the details are used to generate multiple-choice questions (MCs) targeting specific sub-standards;
providing example multiple choice questions (MCQs) for each educational standard, wherein the example MCQ is targeted to at least one sub-standard under that standard to ensure specificity and relevance of the generated MCQ; and
providing stimulus information for stimulus-based standards and sub-standards, wherein a Python function is utilized to generate an image using the stimulus information for corresponding stimulus-based standards and sub-standards.

7. The method of claim 1 wherein validating the generated multiple choice question (MCQ) includes providing feedback to the generator agent if the question is invalid, wherein the generator agent adds the feedback to the question to fix any issues.

8. The method of claim 7 wherein the generator agent adds the feedback for 3 validation attempts and the question is rejected after three validation attempts.

9. The method of claim 1 wherein performing one or more additional validation checks on the multiple choice question (MCQ) includes checking the mathematical correctness and semantic validity of the generated question.

10. The method of claim 1 is utilized to generate one or more mathematical multiple-choice questions (MCQs) aligned to Common Core State Standards (CCSS).

11. A system for guiding a multiagent AI engine to generate and validate one or more multiple-choice questions (MCQs) aligned with educational standards, the system comprises:
one or more processors of a computer system;
memory, coupled to the one or more processors, that stores code and execution of the code by the one or more processors causes the computer system to perform operations comprising:
providing access to a data model including educational standards, wherein the data model includes granular details related to the standards and sub-standards for generating multiple-choice questions (MCQs);
generating prompts to guide the multiagent AI engine in generating the multiple-choice questions (MCQs), wherein the prompts include one or more inputs received from the data model;
transferring the prompts to the multiagent AI engine configured to perform one or more operations comprising:
generating a first draft of at least one multiple choice question (MCQ), via a generator assistant, based on the inputs received from the data model;
validating the generated multiple choice question (MCQ) for correctness and alignment with the educational standards, wherein the question failing validation step is regenerated by the generator assistant for one or more pre-defined cycles;
pre-processing the validated multiple choice question (MCQs) for completeness, formatting, and context-related modifications;
performing one or more additional validation checks on the multiple choice question (MCQ) for identification of any issues, wherein the additional validation checks ensure the question's validity and alignment with educational standards, and the MCQ is discarded if it fails on at least one of the additional checks.

12. The system of claim 11 further comprising running a code-level validation on the multiple-choice question (MCQ) after the pre-processing is done, wherein the code-level validation includes a programmatic check to resolve issues such as invalid JSON and values outside the acceptable range for the educational standards.

13. The system of claim 11 further comprising running a post-processing step after the additional validation checks are completed on the MCQ, wherein the post-processing step utilizes one or more functions to address any static issues in the validated multiple-choice question (MCQ) such as improper formatting of LaTex escape responses.

14. The system of claim 11 wherein the multiagent AI engine includes the generator agent for generating a first draft of the MCQ based on inputs received from the data model, a validator agent configured to assess the basic correctness of the generated MCQ, a formatting agent for making context-related modifications in the validated MCQ, and a validator battery to ensure validity and alignment of the MCQ with the educational standards.

15. The system of claim 11 further comprises a battery validator agent including a series of generative AI agents configured to run one or more additional validation checks on the multiple-choice question (MCQ), wherein the battery validator agent performs qualitative and quantitative checks on the generated question to ensure validity and accuracy of each question against relevant educational standards and sub-standards.

16. The system of claim 11 further comprises:
providing details related to sub-standards under each standard in the data model, wherein the details are used to generate multiple-choice questions (MCs) targeting specific sub-standards;
providing example multiple choice questions (MCQs) for each educational standard, wherein the example MCQ is targeted to at least one sub-standard under that standard to ensure specificity and relevance of the generated MCQ; and
providing stimulus information for stimulus-based standards and sub-standards, wherein a Python function is utilized to generate an image using the stimulus information for corresponding stimulus-based standards and sub-standards.

17. The system of claim 11 wherein validating the generated multiple choice question (MCQ) includes providing feedback to the generator agent if the question is invalid, wherein the generator agent adds the feedback to the question to fix any issues.

18. The system of claim 17 wherein the generator agent adds the feedback for 3 validation attempts and the question is rejected after three validation attempts.

19. The system of claim 11 wherein performing one or more additional validation checks on the multiple choice question (MCQ) includes checking the mathematical correctness and semantic validity of the generated question.

20. The system of claim 11 is utilized to generate one or more mathematical multiple-choice questions (MCQs) aligned to Common Core State Standards (CCSS).
